(19) United States
(12) Patent Application Publication
(10) Pub. No.: US 2009/0167620 A1
(43) Pub. Date: Jul. 2, 2009

(54) ACCESSORY-TYPE ANTENNA FOR VEHICLE

(75) Inventors: Ji Hoon Ha, Ansan (KR); Yung Min Moon, Suwon (KR); Sun Kwon Kim, Seoul (KR)

Correspondence Address: RABIN & Berdo, PC, 1101 14TH STREET, NW, SUITE 500, WASHINGTON, DC, 20005, US

(73) Assignees: Neopulse Co., Ltd., Suwon-si (KR); KIRYUNG ELECTRONICS CO., LTD., Seoul (KR)

(21) Appl. No.: 12/344,394

(22) Filed: Dec. 26, 2008

(30) Foreign Application Priority Data
Dec. 27, 2007 (KR) 10-2007-0139261
May 29, 2008 (KR) 10-2008-0050326

(51) Int. Cl. H01Q 1/32

(52) U.S. Cl. 343/711

(57) ABSTRACT

An antenna for a built-in multimedia receiver in a vehicle to use a multimedia service such as HD radio, DMB, and the like. The antenna may function as a message board that may externally display a predetermined message, such as driver's phone number, as well as receive the multimedia signal. The antenna not only receives a multimedia service signal but also transmits the multimedia service signal to a basic multimedia reproduction device included in the vehicle, thus enabling efficient addition of another multimedia receiver to the vehicle with the minimum wiring.

### CROSS-REFERENCE TO RELATED APPLICATION

This application claims the benefit of Korean Application No. 10-2007-0139261, filed on Dec. 27, 2007, with the Korean Intellectual Property Office, the disclosure of which is incorporated herein by reference.

### BACKGROUND OF THE INVENTION

1. Field of the invention

The present invention relates to an accessory-type antenna for vehicle, and more specifically, to an accessory-type antenna for vehicle that may transmit a multimedia signal to a built-in system in the vehicle and externally display a prescribed message such as driver's phone number and the like, as well as receive a multimedia signal as an antenna for a multimedia receiver mounted in the vehicle to use multimedia services including HD (High-Definition) radio and DMB (Digital Multimedia Broadcasting) services.

2. Description of the Related Art

In recent years, the advent of information-oriented society led to sharp developments in the information communication areas including IT (Information Technology), and various multimedia services based on high-capacity radio data communication technologies have been introduced correspondingly to replace or develop the existing services with rapidity.

As an example, ‘HD (High-Definition) radio’, which generally means American terrestrial digital AM/FM radio technologies, has been rapidly prevailing in North America. The HD radio provides various free additional services, such as weather forecast, traffic situations, news headlines, etc., with an excellent receiver sensitivity and CD-level high sound quality over the existing AM/FM bands (AM:535˜1,605 kHz, FM:88˜108 MHz). As another example, DMB (Digital Multimedia Broadcasting) service which domestically gains popularity is a novel mobile multimedia broadcasting service where broadcasting and communications are combined with each other. The DMB service may provide high-definition contents such as music, text, data, moving pictures, and the like even on the move at the high speed of more than 200 km/h over a frequency band of 800 MHz without separate fee charging, so that its popularity is greatly grown for use in a vehicle together with the HD radio.

In the meanwhile, a dedicated multimedia receiver is required to utilize such a multimedia service including HD radio and DMB. Accordingly, some of newest-model vehicles are released with a multimedia receiver built in the center fascia panel, however, most of vehicles are optionally required to separately mount the multimedia receiver on the dash board or center fascia panel at user's expense. Accordingly, this requires an antenna for the multimedia receiver to be mounted on the dash board or outside the vehicle, or be attached/detached on the ceiling of the vehicle using magnets.

However, such an antenna for multimedia receiver gives rise to various inconveniences during use. For example, the antenna mounted on the dash board in the vehicle may obstruct driver's view or cause the internal space of the vehicle to be narrow when it is taken into consideration that the antenna needs to have the sufficient length to stably receive signals. Further, this type of antenna may be detached due to a sudden stop or sudden start to cause an accident. And, the antenna separately fixed outside the vehicle may do damage to the vehicle, for example, due to drilling work for fixing the antenna, and incur lots of expense. The antenna detachable outside the vehicle by a magnet may be easily detached due to air resistance during high-speed drive of the vehicle and cause a user to suffer from trouble that he/she should attach/detach the antenna by him/herself every time.

Therefore, there is a need of providing an antenna for vehicle that may overcome the above problems.

### SUMMARY OF THE INVENTION

According to an aspect of the present invention, there is provided an accessory-type antenna for vehicle, which may not only solve the problems of existing antenna for vehicle but also provide new functions as a multimedia receiver mounted in a vehicle. Specifically, the antenna according to an aspect of the present invention may be easily and safely attached and detached by anyone without aid of experts. The antenna occupies only a tiny space in the vehicle that has nothing to do with of driving, thus allowing for an efficient use of the space and preventing the vision of the driver from being obscured. Further, this antenna does not cause damage to the vehicle when mounted on the vehicle. Also, this antenna may function as a message board that externally displays a prescribed message such as driver's phone number as well as receive a multimedia service signal.

According to another aspect of the present invention, there is provided an accessory-type antenna for vehicle that includes both a receiving antenna for a multimedia receiver mounted in the vehicle and a transmitting antenna that transmits at least one of an audio signal and a video signal from the multimedia receiver to a built-in A/V system for vehicle, wherein the receiving antenna and the transmitting antenna may be operated at the same time. Accordingly, the multimedia receiver, which interacts with the A/V system for vehicle, may be added in the vehicle with the minimum signal lines.

According to an exemplary embodiment of the present invention, there is provided an accessory-type antenna for vehicle, which is mounted in a vehicle having a built-in multimedia receiver to receive a multimedia service signal, including: a printed circuit board including a receiving antenna unit for receiving the multimedia service signal formed at a first side, a transmitting antenna unit for transmitting an output signal from the multimedia receiver formed at a second side, and a ground electrode arranged between the receiving antenna unit and the transmitting antenna unit to electrically separate the antenna units from each other, the ground electrode having the area broader than that of the transmitting antenna unit; a housing mounted in the vehicle with the printed circuit board accommodated therein, the housing including a message on at least one surface thereof to be externally displayed; and a connector socket that connects the multimedia receiver to a power feeding point of the printed circuit board, wherein each of the antenna units is extended along a separate electrode path that is formed to pass through the ground electrode to be connected to a power feeding point that is located in the area of the ground electrode.

Preferably, the multimedia service signal may be at least one of an HD radio signal including an AM/FM signal and a DMB signal.

Preferably, at least one of the transmitting antenna unit and the receiving antenna unit may include an antenna pattern that is wound in the shape of a line including a penetration hole along the printed circuit board.

Preferably, the antenna pattern may have about ½ to about ¼ wavelengths.

Preferably, the connector socket may be a 3.5phi stereo type connector socket.

Preferably, the accessory-type antenna for vehicle may further include a fixing means that is combined with the housing to fix the housing in the vehicle.

Preferably, the fixing means may be at least one of a holder that is fixed on the dashboard of the vehicle, with the housing being fitted into the holder, and a vacuum sucking pad that is attached on the windshield of the vehicle while being combined with the housing.

Preferably, the receiving antenna unit and the transmitting antenna unit may be connected to the connector line through the 3.5phi stereo type connector socket to be capable of being used simultaneously.

As described above, the accessory-type antenna for vehicle according to the present invention may function as a message board externally displaying a predetermined message such as driver's phone number as well as stably receive a multimedia signal, and therefore, may simultaneously satisfy the two functions, each of which is separately provided in most of vehicles.

Furthermore, the accessory-type antenna for vehicle according to the present invention may be easily and safely detached by anyone without aid of experts, and occupy only a tiny space of the vehicle independent of driving, thus enabling an efficient use of a space and preventing the vision of driver from being obscured. And this antenna does not damage to the vehicle when mounted in the vehicle.

In addition, the accessory-type antenna for vehicle according to the present invention may include both a receiving antenna that may receive high-efficiency multimedia broadcasting and a transmitting antenna that may wirelessly transmit a signal outputted from a multimedia broadcasting receiver to a built-in A/V system for vehicle to allow a user to watch and listen to multimedia broadcasting through the AV system, thus enabling improve the capacity of the multimedia broadcasting receiver and simplify the wiring construction.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a perspective view illustrating an antenna for vehicle according to the present invention;

FIG. 2 is an exploded perspective view illustrating an antenna for vehicle according to the present invention;

FIG. 3 is a plan view illustrating an antenna unit included in an antenna for vehicle according to the present invention;

FIG. 4 is a graph illustrating a standing wave ratio of an antenna for vehicle according to the present invention; and

FIG. 5 is a view illustrating an inner structure of a vehicle to show the mounting position of an antenna for vehicle according to the present invention.

### DETAILED DESCRIPTION OF THE PREFERRED EMBODIMENTS

Hereinafter, exemplary embodiments of the present invention will be described in detail with reference to the accompanying drawings.

The present invention relates to an antenna for a multimedia receiver mounted in the vehicle to use a multimedia service such as HD radio, DMB, and the like, and provides an antenna that may be utilized for various purposes including vehicular management, besides receipt of the multimedia service signal. For this purpose, an aspect of the present invention was directed toward a message board that is attached on the windshield of the vehicle to externally display a predetermined message such as driver's phone number. That is, an aspect of the present invention provides an accessory-type antenna for a multimedia receiver that may function as a message board for vehicle. In particular, the accessory-type antenna according to an aspect of the present invention is simply detachable, enables a high-efficiency use of a space, does not obscure the driver's vision, does not damage to the vehicle because of not requiring a separate perforating process, and may stably receive the multimedia service signal.

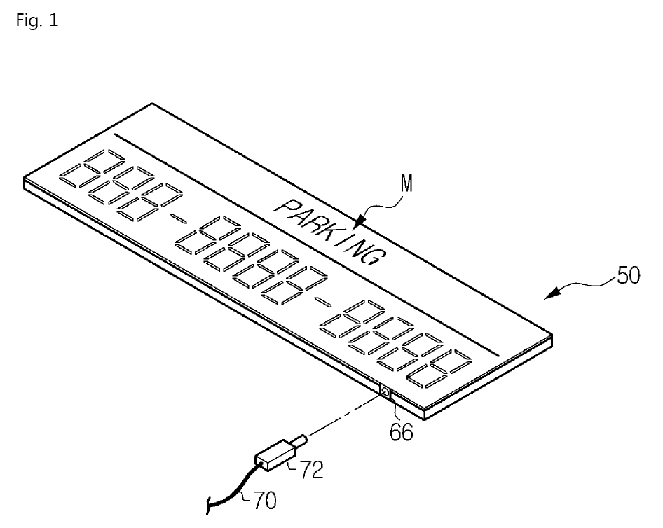

FIG. 1 is a perspective view illustrating an accessory-type antenna 50 for vehicle (hereinafter, simply referred to as “antenna 50 for vehicle”) according to an exemplary embodiment of the present invention.

Referring to FIG. 1, the antenna 50 for vehicle according to the present invention may be shaped as a plate having the predetermined thickness. Driver's phone number, other phrases, and drawings are printed on at least one of front and rear surfaces of the antenna 50 for vehicle with an appropriate combination of characters, numerals, and diagrams as a message M viewed outside. And, a connector socket 66 is provided at a side of the antenna 50 for vehicle, which is connected to a connector line 70 drawn from a multimedia receiver mounted in the vehicle.

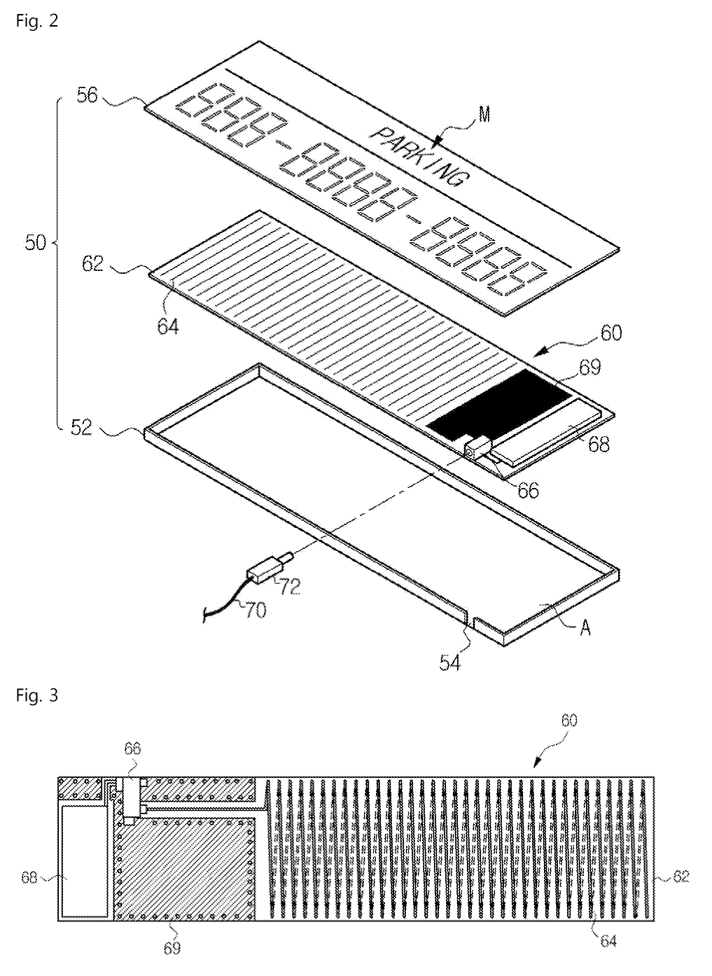

Referring to FIG. 2 which is an exploded perspective view of the antenna 50 for vehicle shown in FIG. 1 along with FIG. 1, the antenna 50 for vehicle according to the present invention includes an antenna unit 60 mounted on a printed circuit board (PCB) 62 and a housing. The housing includes a front housing 52 and a rear housing 56 that receive the antenna unit 60 therebetween to constitute the external appearance.

The antenna unit 60 includes an antenna pattern 64 and a connector socket 66. The antenna pattern 64 is formed of a conductive material on the PCB 62 in the shape of a line. The connector socket 66 is mounted on the PCB 62 to be electrically connected to the antenna pattern 64. Accordingly, the connector line 70, which is drawn from the multimedia receiver mounted in the vehicle, is connected to the antenna pattern 64 via the connector socket 66. For this purpose, a connector pin 72 is provided at an end of the connector line 70.

The housing may include the front housing 52 and the rear housing 56 that are joined to each other, with the antenna unit 60 sandwiched therebetween. The housing may be formed of a light-weight, solid insulation material such as plastics. A predetermined mounting space A is defined in the inside of the housing when the front housing 52 and the rear housing 56 are joined, so that the antenna unit 60 may be accommodated therein. A socket hole 54 is provided at a side of the housing to expose the connector socket 66 of the antenna unit 60. The message M, described above, is printed on the outer surface of at least one of the front and rear housings 52 and 56.

As a consequence, the combination of the front and rear housings 52 and 56, with the antenna unit 60 located therebetween, completes the antenna 50 for vehicle according to the present invention. For use, the connector line 70 drawn from the multimedia receiver is connected to the connector socket 66 and then the antenna 50 for vehicle is fixed at a proper location in the vehicle. Since the message M, viewed outside, has been printed on the outer surface of at least one of the front and rear housings 52 and 56 of the antenna 50 for vehicle, the antenna 50 for vehicle may function as a message board, as well as function as an antenna that transmits a multimedia signal received through the antenna unit 60 to the multimedia receiver via the connector socket 66, and the connector pin 72 and the connector line 70 connected to the connector socket 66.

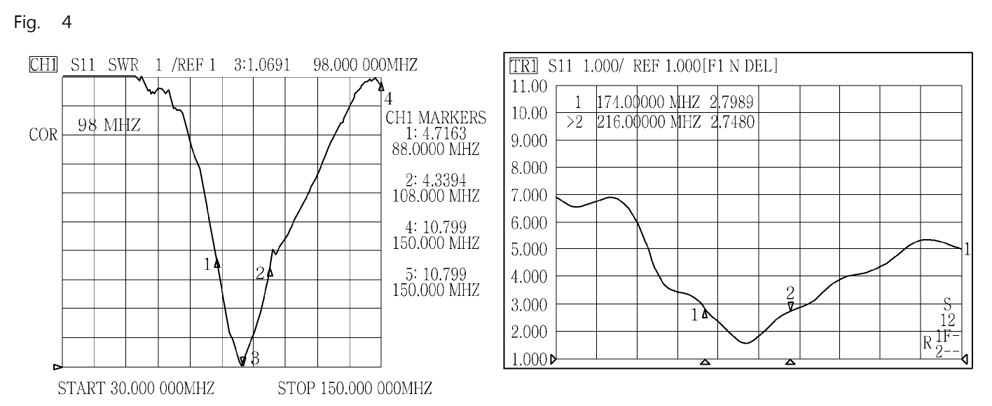

A detailed form of the antenna unit 60 has been shown in FIG. 3. FIG. 3 is a plan view illustrating the antenna unit according to the present invention.

Referring to FIG. 3, the antenna unit 60 according to the present invention is provided on the PCB 62. The antenna pattern 64 is formed in the shape of a line on the nearly whole surface of the PCB 62 through a photolithography process, and the connector socket 66 is provided at a side of the antenna unit 60, which is electrically connected to the antenna pattern 64.

In this case, the antenna pattern 64 is wound in the shape of a coil over the front and rear surface of the PCB 62. According to the use purpose, the antenna pattern 64 may exhibit ½ to ¼ wavelengths, and its length and interval may be adjusted to be capable of receiving both HD radio signals including FA/FM signals and terrestrial DMB signals. Furthermore, the connector socket 66 connected to the antenna pattern 64 employs a 3.5phi stereo socket that may be connected to a corresponding connector pin compatible therewith (see the reference numeral 72 in FIGS. 1 and 2).

Accordingly, a multimedia signal received through the antenna pattern 64 may be transmitted to the multimedia receiver without any loss to allow occupants to receive a multimedia service in the vehicle. In addition, a separate FM transmitter antenna 66 may be mounted on the PCB 62 of the antenna unit 60 and connected to the connector socket 66. Therefore, a sound signal may be transmitted from the multimedia receiver or a separate terminal, such as an MP3 player, a navigator, etc., which are connected to the connector socket 66, to a built-in speaker system mounted in the vehicle or a mini-component speaker system embedded with its own FM tuner in FM radio bands.

As such, a user of the antenna 50 for vehicle according to the present invention may receive the sound signal outputted from the multimedia receiver or separate terminal such as MP3 player and navigator through the built-in speaker in the vehicle. The user may receive the sound signal received through the multimedia receiver under best conditions through an audio system for vehicle that becomes more sophisticated. Also, the user may receive and reproduce audio/video signals outputted through the multimedia receiver with a broadcast receiving means (for example, TV tuner and the like) embedded in an audio/video system for vehicle when the FM transmitter antenna 68 is replaced with a transmitting antenna for transmission of other signals (for example, UHF band antenna and the like).

That is, the antenna 50 for vehicle according to the present invention has a receiving antenna for receiving multimedia broadcasting signals and a transmitting antenna for transmitting outputs from the multimedia broadcasting receiver, which are integrally formed without any interference therebetween upon transmission/receipt of a signal, and this may greatly reduce the number of connecting cables necessary to additively mount the multimedia receiver in the vehicle.

In the meanwhile, the antenna pattern 64 for receipt and the FM transmitter antenna 68 for transmission are separated from each other by a ground surface 69 which is broader than the FM transmitter antenna 68 to separate the transmitting and receiving signals from each other without any interference. The connector socket 66 is provided in the area of the ground surface 69. And, the antenna pattern 64 for receipt and the FM transmitter antenna 68 for transmission are connected to the connector socket 66 through a path which is formed to pass through the ground surface 69. Such a broad ground surface 69 may greatly decrease interference between signals and improve the capacity of each antenna 64 and 68.

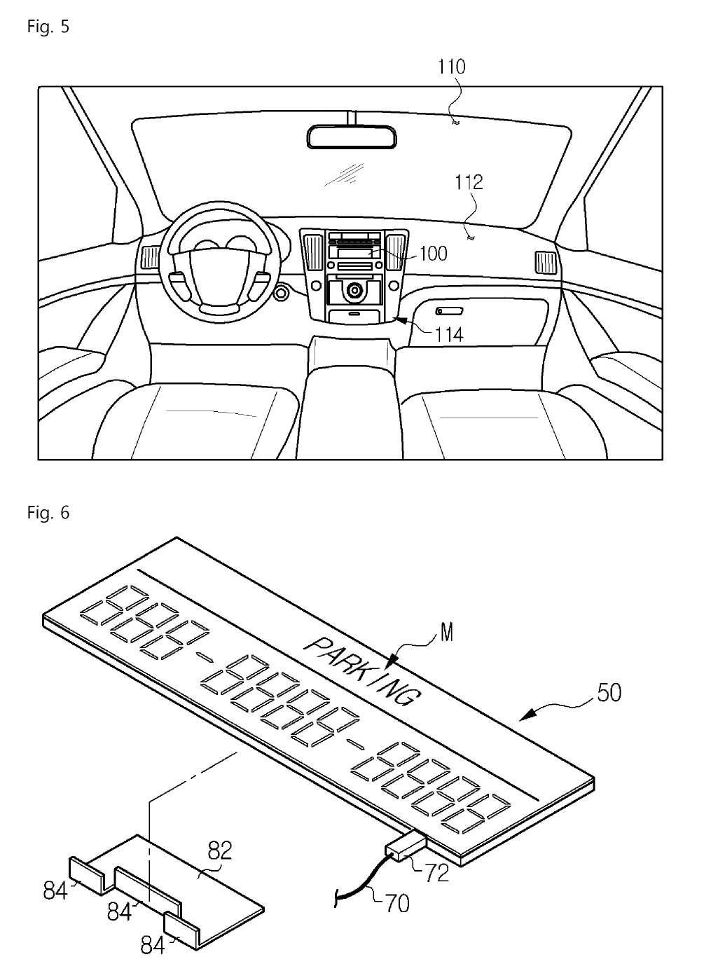

FIG. 4 is a graph illustrating a standing wave ratio of the antenna 50 for vehicle according to the present invention, wherein the antenna pattern 64 is adapted to have ¼ wavelengths.

It has been verified from field measurement data measured during operation of the vehicle for a comparison between a general antenna and the antenna 50 for vehicle according to the present invention that the antenna 50 for vehicle may sufficiently replace the general antenna in AM bands, and it has been verified from the data measured in a sealed shield room that the antenna 50 for vehicle exhibited the receiver sensitivity more than that of a common active AM/FM antenna in FM bands. Further, it has been verified from the field measurement data measured during actual operation of the vehicle that the antenna 50 for vehicle may receive terrestrial DMB signals in a sufficiently stable level.

In the meanwhile, the antenna 50 for vehicle according to the present invention enables a high-efficiency use of a space since there is no necessity of providing a separate message board which is used for most of vehicles to show some information such as driver's phone number. Besides, it is possible to utilize the FM transmitter antenna inevitable for a transmitter that transmits signals to the built-in audio system in the vehicle, which is called ‘radio car-pack’, as well as the receiving antenna for various purposes, and this may greatly reduce the number of cables necessary for installation and applications, thus enabling the inside of the vehicle to be kept clean.

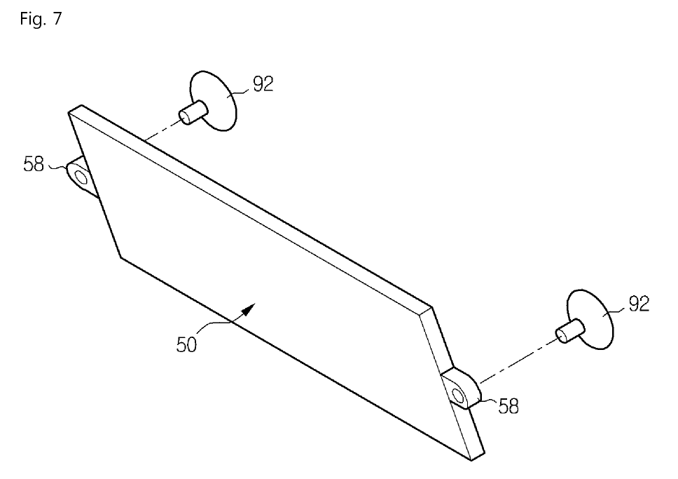

FIG. 5 is a perspective view illustrating the inside of a vehicle, which shows a right mounting position of the antenna 50 for vehicle according to the present invention, wherein a windshield 110, a dashboard 112, and a center fascia panel 114 are viewed.

Because of playing a role as a message board, the antenna 50 for vehicle according to the present invention may be mounted at an upper, lower, or side portion of the windshield 110, or an appropriate portion of the dashboard 112 without obscuring the vision of a driver similarly to a general message board. For this purpose, the antenna 50 for vehicle according to the present invention may have a separate fixing means. FIGS. 6 and 7 show a few examples of the fixing means for the antenna 50 for vehicle according to the present invention.

First, a holder 82 that fixes the antenna 50 for vehicle on the dashboard is shown in FIG. 6 as a first fixing means of the antenna 50 for vehicle according to the present invention. The holder 82 is firstly fixed on the dashboard of the vehicle by a double-sided adhesive tape or screws and then the antenna 50 for vehicle is fitted into between plural fixing portions 84 that protrude upward from the holder 82, so that the antenna 50 for vehicle may be tightly secured by the fixing portions 84.

Secondly, a vacuum sucking pad 90 that supports the antenna 50 for vehicle on the windshield is shown in FIG. 7 as a second fixing means of the antenna 50 for vehicle according to the present invention. A predetermined insertion portion 58 is provided at at least one side of the antenna 50 for vehicle. At least one vacuum sucking pad 90 is inserted into the insertion hole 58 and attached on the windshield of the vehicle, thus enabling the antenna 50 for vehicle to be firmly secured on the windshield of the vehicle.

In the meanwhile, the antenna 50 for vehicle according to the present invention may also display a moving-picture color message through a displaying means such as LEDs or liquid crystal displays although not described in detail. In addition, the antenna 50 for vehicle according to the present invention may provide various additional functions including emission of light or fragrance. For this purpose, other components may be separately mounted on the front and rear housings 52 and 56, and these construction fall within general technical spirits. Further, the fixing means for fixing the antenna 50 for vehicle according to the present invention may be also varied diversely.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An accessory-type antenna mounted in a vehicle having a built-in multimedia receiver, comprising:
a printed circuit board including
a receiving antenna unit for receiving a multimedia service signal, the receiving antenna unit being formed at a first side of the printed circuit board,
a transmitting antenna unit for transmitting an output signal from the multimedia receiver, the transmitting antenna unit being formed at a second side of the printed circuit board, and
a ground electrode arranged between the receiving antenna unit and the transmitting antenna unit to electrically separate the antenna units from each other, the ground electrode having an area broader than that of the transmitting antenna unit;
a housing mounted in the vehicle with the printed circuit board accommodated therein, the housing including a message on at least one surface thereof to be externally displayed; and
a connector socket that connects the multimedia receiver to a power feeding point of the printed circuit board, wherein
each of the antenna units is extended along a separate electrode path that is formed to pass through the ground electrode to be connected to the power feeding point that is located in the area of the ground electrode.

2. The accessory-type antenna of claim 1, wherein
the multimedia service signal is at least one of an HD radio signal including an AM/FM signal and a DMB signal.

3. The accessory-type antenna for vehicle of claim 1, wherein
at least one of the transmitting antenna unit and the receiving antenna unit includes an antenna pattern that is wound in the shape of a line including a penetration hole along the printed circuit board.

4. The accessory-type antenna of claim 3, wherein
the antenna pattern has about ½ to about ¼ wavelengths.

5. The accessory-type antenna of claim 1, wherein the connector socket is a 3.5phi stereo type connector socket.

6. The accessory-type antenna of claim 1, further comprising:
a fixing means that is combined with the housing to fix the housing in the vehicle.

7. The accessory-type antenna of claim 6, wherein
the fixing means is at least one of a holder that is fixed on a dashboard of the vehicle, with the housing being fitted into the holder, and a vacuum sucking pad that is attached on a windshield of the vehicle while being combined with the housing.

8. The accessory-type antenna of claim 5, wherein
the receiving antenna unit and the transmitting antenna unit are connected to a connector line drawn from the multimedia receiver through the 3.5phi stereo type connector socket, the receiving antenna unit and the transmitting antenna unit being used simultaneously.
